(19) United States
(12) Patent Application Publication
(10) Pub. No.: US 2004/0100369 A1
(43) Pub. Date: May 27, 2004

(54) Service alarm system for a boat propulsion unit

(76) Inventors: Hitoshi Motose, Shizuoka (JP); Shingo Igarashi, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/695,703

(22) Filed: Oct. 29, 2003

(30) Foreign Application Priority Data
Oct. 31, 2002 (JP) 2002-318768

(51) Int. Cl. B60Q 1/00

(52) U.S. Cl. 340/457.4

(57) ABSTRACT

A service alarm system for a boat propulsion unit monitors a lubricant service life. The system informs the watercraft operator when the lubricant is no longer suitable to provide proper lubricating properties for the boat propulsion unit. The alarm system informs the operator by sounding an audible alarm or illuminating a visual alarm through at least one light. By informing the operator inadequate lubrication properties, the user can perform proper service of the watercraft to ensure safe and enjoyable watercraft operation.

### PRIORITY INFORMATION

This application is based on and claims priority under 35 U.S.C. § 119 to Japanese Patent Application No. 2002-318768, filed on Oct. 31, 2002, the entire contents of which are hereby expressly incorporated by reference herein.

### BACKGROUND OF THE INVENTION

1. Field of the Invention

The invention relates to a watercraft service alarm system for monitoring a lubrication service interval. The system informs the watercraft operator when the lubrication service interval has expired according to a predetermined time duration.

2. Description of the Related Art

Watercraft (e.g., personal watercraft or boats) typically incorporate internal combustion engines along with propulsion units to provide power and propel the watercraft in a variety of popular applications. The internal combustion engines can operate according to the two-cycle (two-stroke) operating principle or the four-cycle (four-stroke) operating principle. Internal combustion engines use lubricants to lubricate various engine components allowing the engine to operate correctly and provide a long service life.

Although modern lubricants do retain their lubricating properties for extended lengths of time, lubricants do have a limited service period. Before the lubricant begins to lose its operating properties, the lubricant must be renewed to continue providing the internal combustion engine with adequate lubricating properties.

It is possible that the operator of the watercraft forgets to renew the lubricant in the internal combustion engine, therefore a need exists for an improved lubrication service alarm that reminds the operator of the proper time to renew the lubricant in the internal combustion engine.

### SUMMARY OF THE INVENTION

It is an object of this invention to provide a

[symbol]

One aspect of an embodiment in accordance with the present invention is a

[symbol]

Another aspect in accordance with embodiments of the present invention is a

[symbol]

### BRIEF DESCRIPTION OF THE DRAWINGS

Preferred embodiments in accordance with aspects of the present invention will be described below in connection with the accompanying drawing figures in which:

FIG. 1 illustrates a side view of a watercraft with an outboard motor including a lubrication service alarm;

FIG. 2 illustrates a block diagram illustrating various communication paths and components of a watercraft service control system;

FIG. 3 illustrates a front view of a display panel that shows a switch, alarm lights, and reset buttons;

FIG. 4 illustrates a flowchart of a control routine performed by the watercraft service control system that illustrates control of a service alarm;

FIG. 5 illustrates another front view of a display panel that shows a switch, an alarm light, and a reset button;

FIG. 6 illustrates another front view of a display panel that shows a switch and a plurality of alarm lights, and

FIG. 7 illustrates another front view of a display panel that shows a switch and an alarm light.

### DETAILED DESCRIPTION OF THE PREFERRED EMBODIMENT

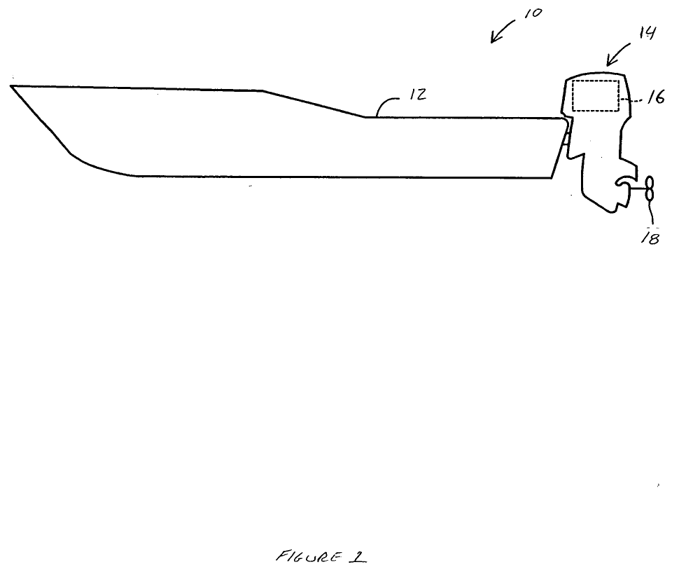

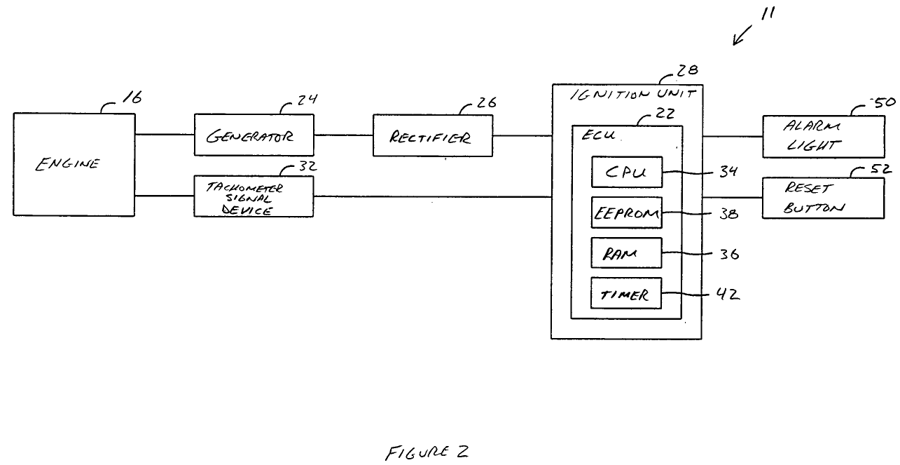

FIG. 1 shows a watercraft 10 equipped with a service control system 11 (FIG. 2) that comprises a lubrication service interval warning device and a system for reminding the operator of a lubrication service interval. The watercraft comprises a hull 12 and an outboard motor 14. The outboard motor 14 includes an engine 16 that drives a propeller 18 through a transmission (not shown).

The engine 16 in the illustrated embodiment preferably operates on a four-cycle combustion principle. The engine 16 has a cylinder block (not shown). The presently preferred cylinder block defines at least on cylinder bore (not shown). When more than one cylinder bore is defined, the cylinder bores extend generally horizontally and are generally vertically spaced from one another. As used in this description, the term “horizontally” means that the subject portions, members or components extend generally in parallel to the water line (not shown) when the associated watercraft 10 is substantially stationary with respect to the water line and when a drive unit (not shown) is not tilted. The term “vertically” in turn means that portions, members or components extend generally normal to those that extend horizontally.

This type of engine, however, merely exemplifies one type of engine on which various aspects and features of the present invention can be suitably used. Engines having other numbers of cylinders and having other cylinder arrangements (V, W, opposing, etc.) also can employ various features, aspects and advantages of the present invention. In addition, the engine can be formed with separate cylinder bodies rather than a number of cylinder bores formed in a cylinder block. Regardless of the particular construction, the engine preferably comprises an engine body that includes at least one cylinder bore.

The engine 16 also comprises an air induction system or device (not shown). The air induction system draws air from within a cavity (not shown) to at least one combustion chamber (not shown). The air induction system preferably comprises at least one intake passage (not shown). Each cylinder bore preferably has at least one intake port (not shown) defined in a cylinder head member (not shown). The intake port can be selectively opened and closed by at least one intake valve (not shown).

The engine 16 also comprises an exhaust system that guides burnt charges, i.e., exhaust gases, to a location outside of the outboard motor 14. Each cylinder bore preferably has at least one exhaust port (not shown) defined in the cylinder head member. The exhaust port can be selectively opened and closed by at least one exhaust valve (not shown). The construction of each exhaust valve and the arrangement of the exhaust valve are substantially the same as the intake valve and the arrangement thereof, respectively.

An exhaust manifold (not shown) preferably is disposed next to the exhaust port and extends generally vertically. The exhaust manifold communicates with the combustion chamber through the exhaust ports to collect exhaust gases therefrom. The exhaust manifold is coupled with an exhaust passage of an exhaust guide member (not shown). When the exhaust port is opened, the combustion chamber communicates with the exhaust passage through the exhaust manifold.

The engine 16 preferably has a carburetor or a fuel injection system. The fuel injection system can be a port or a manifold fuel injection system. The fuel injection system preferably comprises at least one fuel injector (not shown) with one fuel injector allotted for each of the respective combustion chambers through suitable fuel conduits. Each fuel injector preferably has an injection nozzle directed toward the associated intake passage adjacent to the intake ports.

The engine 16 further comprises an ignition or firing system. An electronic control unit (ECU) 22 controls various aspects of the engine 16. Each combustion chamber is provided with at least one spark plug (not shown) that is connected to the ECU 22 through an igniter (not shown) so that ignition timing is also controlled by the ECU 22. Each spark plug or igniter has electrodes that are exposed into the associated combustion chamber and are spaced apart from each other with a small gap. The spark plug generates a spark between the electrodes to ignite an air/fuel charge in the combustion chamber at selected ignition timing under control of the ECU 22.

In the illustrated engine 16, at least one piston (not shown) reciprocates between top dead center and bottom dead center. When a crankshaft (not shown) makes two rotations, the piston generally moves from the top dead center to the bottom dead center (the intake stroke), from the bottom dead center to the top dead center (the compression stroke), from the top dead center to the bottom dead center (the power stroke) and from the bottom dead center to the top dead center (the exhaust stroke). During the four strokes of the pistons, at least one camshaft (not shown) makes one rotation and actuates the intake valve and the exhaust valve to open the intake ports during the intake stroke and to open exhaust ports during the exhaust stroke, respectively.

During engine operation, heat builds in the engine 16. The illustrated engine 16 thus includes a cooling system to cool the engine 16. The outboard motor 14 preferably employs an open-loop type water cooling system that introduces cooling water from the body of water surrounding the outboard motor 14 and then discharges the water to the body of water. The cooling system includes one or more water jackets defined within the engine 16 through which the water travels to remove heat from the engine 16.

The engine 16 also preferably includes a lubrication system. A closed-loop type system preferably is employed in the illustrated embodiment. The lubrication system comprises a lubricant tank defining a reservoir, which preferably is positioned within a driveshaft housing (not shown). An oil pump (not shown) is provided at a desired location, such as atop the driveshaft housing, to pressurize the lubricant oil in the reservoir and to pass the lubricant oil through a suction pipe toward certain engine portions, which desirably are lubricated, through lubricant delivery passages. The engine portions that need lubrication include, for example, but not limited to crankshaft bearings (not shown), connecting rods (not shown) and the pistons. Lubricant return passages (not shown) also are provided to return the oil to the lubricant tank for re-circulation. The lubrication system includes the service control system 11, which will be described in greater detail below.

The transmission preferably is provided between a driveshaft (not shown) and a propulsion shaft (not shown), which lie generally normal to each other (i.e., at a 90° shaft angle) to couple together the two shafts by bevel gears. The transmission includes a switchover mechanism (not shown) that is configured to change a rotational direction of the propeller 18 between forward, neutral or reverse. The switchover mechanism typically comprises a dog clutch and a shift unit that operates the dog clutch. At the forward and reverse positions, which are propulsion positions, the propeller 18 propels the watercraft 10 forward and backward, respectively. At the neutral position, which is a-non-propulsion position, the propeller 18 does not propel the watercraft 10 because the propulsion shaft is disconnected from the driveshaft.

Preferably, the switchover mechanism is interconnected with a throttle valve linkage (not shown). A single control lever, which is the foregoing throttle lever, is connected to not only a throttle valve (not shown) but also to the switchover mechanism. The single control lever therefore controls both the throttle valve and the switchover mechanism in an interrelationship such that the throttle valve is always closed (or almost closed) when the transmission is placed in the neutral position by the switchover mechanism. The throttle linkage can be released from the switchover mechanism for an engine revving operation.

With reference to FIG. 2, the service control system 11 is shown. Along with the engine 16 the outboard motor 14 includes a generator 24, a rectifier 26, an ignition unit or module 28, and a tachometer signal unit or module 16. The ECU 22 includes a central processing unit (CPU) 34; at least two memory allocations comprising a random access memory (RAM) 36 and an electrically erasable programmable read-only memory (EEPROM) 38. A lubricant service timer 42 records the engine 16 run time, i.e. the time that the engine 16 is actually being operated.

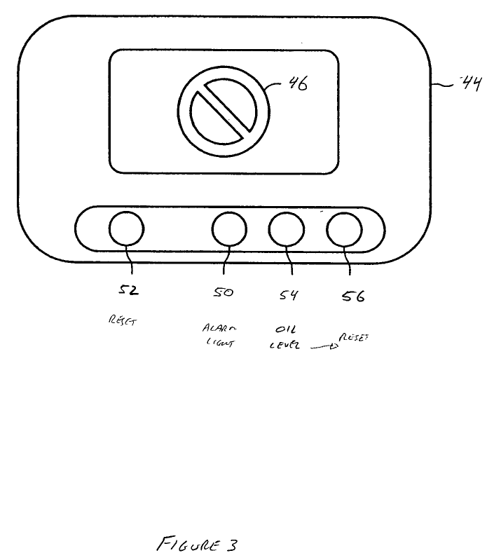

The hull 12 also includes a display unit 44 (FIGS. 3 and 5-7) that includes a main switch 46. The main switch 46 generally starts or stops the engine 16 through a key (not shown). When the main switch 46 is closed, a starter relay (not shown) transfers a voltage from a battery (not shown) to activate a starter motor (not shown) to initiate engine operation. An engine stop switch (not shown) can cause the ECU 22 to cease engine operation. The watercraft 10 may also include other systems for controlling when the engine is stopped, as is well known by persons skilled in the art.

The battery also supplies power to other various watercraft components. The battery is charged by the generator 24 mounted on the engine 16. The generator 24 delivers an AC output voltage to the rectifier 26 to supply the battery with a rectified DC input voltage.

With reference to FIG. 3, the display unit 44 is shown. One preferred embodiment of the display unit 44 comprises at least one service alarm light 50, a service alarm light reset button 52 to reset the service alarm light 50, a lubricant level warning light 54, and a lubricant level warning light reset button 56 to reset the lubricant level warning light 54.

When the amount of lubricant inside the engine 16 falls below a predetermined level the lubricant level warning light 54 illuminates informing the operator that an insufficient amount of lubricant is present in the engine 16. An insufficient amount of lubricant inside the engine 16 can cause harm to engine surfaces that require lubrication to operate such as, but not limited to bearings, pistons, and cylinders. The lubricant level warning light reset button 56 allows the operator of the watercraft 10 to confirm that there is an insufficient amount of lubricant inside the engine 10 and to turn off the lubrication level warning light 54. Turning off the lubrication level warning light 54 not only allows the operator to confirm the insufficient amount of lubricant inside the engine 16, it also allows the operator to operate the watercraft safely by preventing any distraction from the lubrication level warning light 54.

The lubrication level warning light 54 can be initiated at any time when the lubricant level is too low. The lubrication level warning light 54 can also be initiated or for a predetermined amount of time during engine starting when the lubricant level is too low. Alerting the operator for a predetermined amount of time every time during starting that the lubricant level is too low consistently reminds the operator to remedy the low lubricant level.

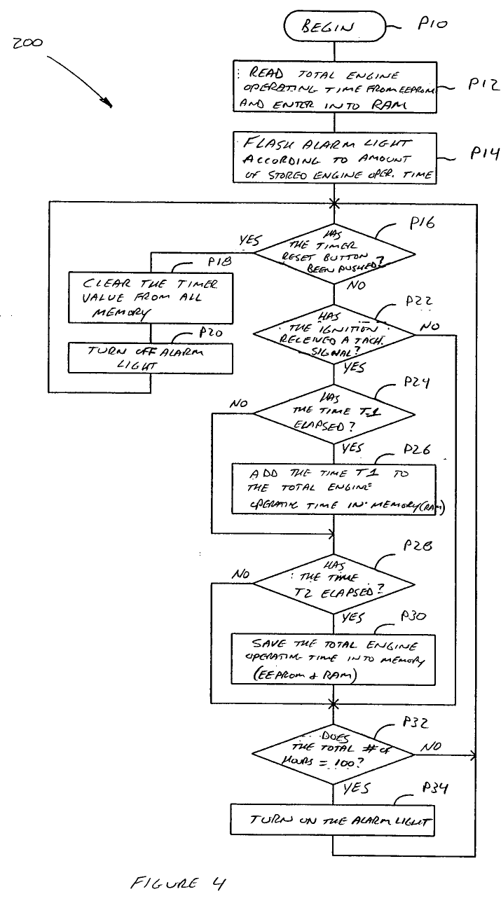

The service alarm light 50 allows the operator to be reminded when the lubricant should be renewed. When the engine 16 is running the tachometer signal device 32 sends a tachometer signal to the ECU 22. The ECU 22 initiates the lubricant service timer 42 whenever the tachometer signal 32 is received. Therefore, whenever the engine 16 is running the lubricant service timer 42 records the amount of engine operating time. The ECU 22 stores the engine operating time data received from the lubricant service timer 42 in the RAM 36. The ECU 22 then transfers the engine operating time data into the EEPROM 38. The process with which the ECU 22 determines when to initiate the service alarm light 50 will be explained in further detail by a control routine 200 of FIG. 4.

FIG. 4 illustrates a control routine 200 that it is arranged and configured in accordance with certain features, aspects, and advantages of the present invention. The control routine 200 begins at a first operation block P10 an moves to an operation block P12 where the total engine operating time stored in the EEPROM 38 is read and entered into the RAM 36. The control routine 200 then moves to an operation block P14.

In operation block P14 the lubrication service alarm light 50 is activated according to the amount of stored engine operating time. For example, if the total amount of engine operating time stored in memory ranges from 0 to 33.3 hours, the alarm light 50 can flash once. If the total amount of engine operating time stored in memory ranges from 33.3 to 66.6 hours, the alarm light 50 can flash twice. If the total amount of engine operating time stored in memory ranges from 66.6 to 99.9 hours, the alarm light 50 can flash 3 times. The control routine 200 then moves to a decision block P16.

In decision block P16 it is determined if the timer reset button 52 has been pushed. In decision block P16 if it is determined that the timer reset button 52 has been pushed, the control routine 200 moves to an operation block P18. If, however, in decision block P16 it is determined that the timer reset button has not been pushed, the control routine 200 moves to a decision block P22.

In operation block P18 all timer values are cleared from all memory. The memory can now accept new engine operating time from a new lubrication time interval. The control routine then moves to an operation block P20 where the lubrication alarm light 50 is turned off. The control routine 200 then returns to decision block P16.

In decision block P22 it is determined if the ECU 22 has received a tachometer signal from the tachometer signal device 32. The signal received from the tachometer signal device 32 initiates from a signal received from the ignition unit 28. The tachometer signal device takes the ignition signal from the ignition unit 28 and delivers a tachometer signal indicative of engine operation. In decision block P22 if it is determined that the ECU 22 has not received the tachometer signal from the tachometer signal device 32, i.e. the engine is not operating, the control routine 200 moves to a decision block P32.

If, however, in decision block P22 it is determined that the ignition has received a tachometer signal, i.e. the engine is running, the control routine 200 moves to a decision block P24.

In decision block P24 it is determined if a time T1 has elapsed since the last time the total engine operating time was updated, i.e. the last time the ECU updated the total engine operating time in the RAM. Therefore, T1 represents a time interval frequency when the engine operating time data is recorded to the RAM. The time T1 can represent a predetermined amount of engine operating time, for example 10 milliseconds. If in decision block P24 the time T1 has not elapsed, the control routine bypasses an operation block P26 to a decision block P28.

If, however, in decision block P24 it is determined that the time T1 has elapsed, the control routine moves to the operation block P26.

In operation block P26 the time T1 is added to the total engine operating time in memory (RAM). The control routine 200 then moves to a decision block P28.

In decision block P28 it is determined if a time T2 has elapsed. T2 can represent a time interval frequency when the engine operating time data is transferred from the RAM to the EEPROM. The time T2 can represent a predetermined amount of engine operating time, for example 1 second. In decision block P22 if the time T2 has not elapsed, the control routine 200 moves to the decision block P32. If, however, in decision block P28 it is determined that the time T2 has elapsed, the control routine 200 moves to an operation block P30.

In operation block P30 the total engine operating time is saved into memory (EEPROM and RAM). The control routine 200 allows the total engine operating time to be constantly updated and preserved in the EEPROM. When the engine is shut off only the engine operating time recorded in the RAM memory is lost. The total amount of engine operating time located in the RAM that can be lost due to engine shut down is one second because T2 represents a time period of one second. The control routine 200 then moves to the decision block P32.

In decision block P32 it is determined if the total number of operating hours equals 100 hours. In decision block P32 if it is determined that the total number of operating hours does not equal 100 hours, the control routine 200 returns to the decision block P16.

If, however, in decision block P32 it is determined that the total number of operating hours does equal 100 hours, the control routine 200 moves to an operation block P34 where the ECU 22 initiates the alarm light 50. The control routine 200 then returns to the decision block P16.

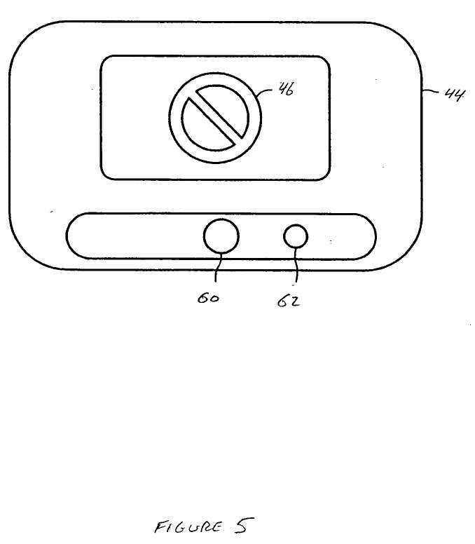

With reference to FIGS. 5-7, various preferred embodiments of the display unit 44 will be described.

The display unit 44 illustrated in FIG. 5 comprises the main switch 46, a warning light 60 that can inform the operator when the lubricant level is below a predetermined level and when the total number of operating hours exceeds a predetermined amount, and a reset button 62. The warning light 60 of the preferred embodiment of FIG. 5 can inform the operator of both the lubricant level and the total operating time of the engine through various possibilities including, but not limited to an audible alarm and/or a visual alarm. The visual alarm can comprise different color light emitting diodes (LED) (not shown) and a number of different flashing light frequencies. Using one warning light with numerous LEDs and/or different flashing frequencies allows for a simple, compact design and less expensive construction. The reset button 62 allows the operator to reset the total accumulated engine operating time after a lubricant service has been performed on the engine 16.

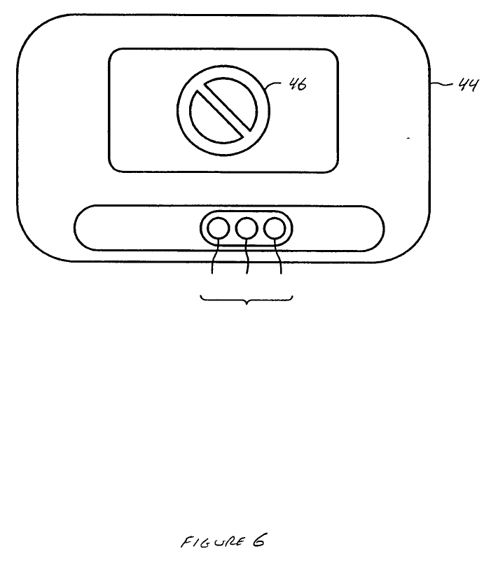

FIG. 6 illustrates another preferred embodiment of the display unit 44. The display unit 44 comprises the main switch 46 and a lubricant warning light display 66. The warning light display 66 comprises three different colored lights including, but not limited to a green light 68, a yellow light 70, and a red light 72. As the predetermined lubricant service time period elapses, the different colored lights illuminate to inform the operator of the remaining time until a lubricant service is necessary.

For example, when the operator turns the main switch 46 to start the engine 16 at least one light from the warning light display 66 illuminates. If a first predetermined lubricant time period has not yet elapsed the green light 68 can illuminate to inform the operator that the lubricant can still provide the engine with the required lubrication properties.

If the first predetermined lubricant time period has elapsed, however a second predetermined lubricant time period has not elapsed, the yellow light 70 can illuminate. The illumination of the yellow light 70 can inform the operator that the lubricant can still provide the engine with required lubrication properties, however the lubricant is approaching a state where it will no longer be able to provide the engine with the required lubrication properties. During this predetermined lubricant time period the lubricant should be changed to continue to provide the engine 16 with the required lubrication properties.

If the second predetermined lubricant time period has elapsed the red light 72 can illuminate to inform the operator that the lubricant no longer possesses the correct required lubrication properties for the engine 16. When the red light 72 illuminates the lubricant should be renewed immediately to allow the engine to provide the operator with a long service life.

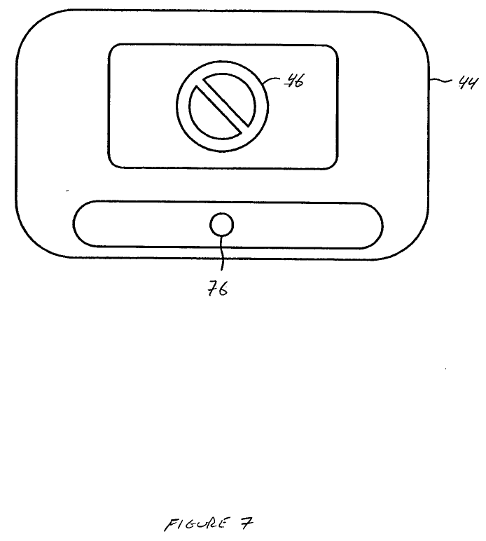

FIG. 7 illustrates another preferred embodiment of the display unit 44. The display unit 44 comprises the main switch 46 and a single lubricant warning light 76. The single lubricant alarm light 76 can flash at different frequencies during a predetermined time period according to the amount of the predetermined lubricant time period that has already elapsed. For example, if a predetermined lubricant time period of 0 to 9 hours has not elapsed, the single lubricant alarm warning light 76 can flash once informing the operator that the lubricant can still provide the engine with the required lubrication properties.

For a predetermined lubricant time period of 9-19 hours, the single lubricant warning light 76 can flash twice. The single warning lubricant light 76 flashing twice can inform the operator that the lubricant can still provide the engine with required lubrication properties, however the lubricant is approaching a state where it will no longer be able to provide the engine with the required lubrication properties.

If the predetermined lubricant time period exceeds 19 hours, the single warning lubricant light 76 can inform the operator that the lubricant no longer possesses the correct required lubrication properties for the engine 16. When the single lubricant alarm light 76 illuminates, the lubricant should be renewed immediately to allow the engine to provide the operator with a long service life.

The length of the predetermined lubricant time periods can vary depending on the type of engine and the environment in which the engine is operated. The lubricant time periods described above are only some of the possible lubricant time periods and are not meant to limit the preferred embodiments of the present invention. Other lubricant time periods can be used and are dependent on manufacturer discretion.

Although the present invention has been described in terms of a certain preferred embodiments; other embodiments apparent to those of ordinary skill in the art also are within the scope of this invention. Thus, various changes and modifications may be made without departing from the spirit and scope of the invention. For instance, various steps within the routines may be combined, separated, or reordered. In addition, some of the indicators sensed (e.g., engine speed and throttle position) to determine certain operating conditions (e.g., rapid deceleration) can be replaced by other indicators of the same or similar operating conditions. Moreover, not all of the features, aspects and advantages are necessarily required to practice the present invention. Accordingly, the scope of the present invention is intended to be defined only by the claims that follow.

What is claimed is:

1. A watercraft comprising an internal combustion engine, the internal combustion engine comprising an engine body, a movable member relative to the engine body and a lubrication system, the lubrication system comprising a lubricant used to lubricate at least the movable member, a control system comprising a lubricant service monitoring system, the lubricant service monitoring system comprising a timer, at least one memory allocation, and an alarm, the timer recording an engine operating time value, the memory allocation holding the engine operating time value, an alarm unit responsive to output a perceptible alarm when predetermined engine operating time value limits have been reached.

2. The watercraft of claim 1, wherein the alarm unit can output the perceptible alarm at a predetermined alarm frequency.

3. The watercraft of claim 2, wherein the alarm frequency can increase at a rate proportionate to the predetermined engine operating time value limits.

4. The watercraft of claim 3, wherein the perceptible alarm is audible.

5. The watercraft of claim 3, wherein the perceptible alarm is visual.

6. The watercraft of claim 5, wherein the visual perceptible alarm comprises at least one light.

7. The watercraft of claim 5, wherein the visual perceptible alarm is at least one colored light.

8. The watercraft of claim 4, wherein the perceptible alarm is also visual.

9. The watercraft of claim 8, wherein the visual perceptible alarm comprises at least one light.

10. The watercraft of claim 8, wherein the visual perceptible alarm is at least one colored light.

11. The watercraft of claim 1, wherein the engine operating time value allocated in the memory can be reset.

12. The watercraft of claim 1, wherein the perceptible alarm can be reset.

13. The watercraft of claim 1, wherein the memory allocation can comprise a RAM and an EEPROM.

14. The watercraft of claim 13, wherein the RAM is updated with the engine operating time at a predetermined frequency.

15. The watercraft of claim 13, wherein the EEPROM is updated with the engine operating time from the RAM at a predetermined frequency.

16. A method for determining when a lubricant no longer possesses proper lubricant properties, the lubricant lubricating at least one movable member within an internal engine, the internal engine being controlled by a control unit, the control unit comprising a lubricant service monitoring system, at least one memory allocation and a perceptible alarm, the method comprising the lubricant service monitoring system recording an engine operating time value into the memory allocation and activating the perceptible alarm when the allocated engine operating time value exceeds a predetermined value.

17. The method of claim 16, wherein the alarm unit can activate the perceptible alarm at a predetermined alarm frequency.

18. The method of claim 17, wherein the alarm frequency can increase at a rate proportionate to the predetermined engine operating time value limits.

19. The method of claim 18, wherein the perceptible alarm is audible.

20. The method of claim 18, wherein the perceptible alarm is visual.

21. The method of claim 20, wherein the visual perceptible alarm comprises at least one light.

22. The method of claim 20, wherein the visual perceptible alarm is at least one colored light.

23. The method of claim 19, wherein the perceptible alarm is also visual.

24. The method of claim 23, wherein the visual perceptible alarm comprises at least one light.

25. The method of claim 23, wherein the visual perceptible alarm is at least one colored light.

26. The method of claim 16, wherein the engine operating time value allocated in the memory can be reset.

27. The method of claim 16, wherein the perceptible alarm can be reset.

28. The method of claim 16, wherein the memory allocation can comprise a RAM and an EEPROM.

29. The method of claim 28, wherein the RAM is updated with the engine operating time at a predetermined frequency.

30. The method of claim 29, wherein the EEPROM is updated with the engine operating time from the RAM at a predetermined frequency.

31. A machine comprising an internal combustion engine, the internal combustion engine comprising an engine body, a movable member relative to the engine body and a lubrication system, the lubrication system comprising a lubricant used to lubricate at least the movable member, a control system comprising a lubricant service monitoring system, the lubricant service monitoring system comprising a timer, at least one memory allocation, and an alarm, the timer recording an engine operating time value, the memory allocation holding the engine operating time value, an alarm unit responsive to output a perceptible alarm when a predetermined engine operating time value limit has been reached.

32. The machine of claim 31, wherein the alarm unit can output the perceptible alarm at a predetermined alarm frequency.

33. The machine of claim 32, wherein the alarm frequency can increase at a rate proportionate to the predetermined engine operating time value limits.

34. The machine of claim 33, wherein the perceptible alarm is audible.

35. The machine of claim 33, wherein the perceptible alarm is visual.

36. The machine of claim 35, wherein the visual perceptible alarm comprises at least one light.

37. The machine of claim 35, wherein the visual perceptible alarm is at least one colored light.

38. The machine of claim 34, wherein the perceptible alarm is also visual.

39. The machine of claim 38, wherein the visual perceptible alarm comprises at least one light.

40. The machine of claim 38, wherein the visual perceptible alarm is at least one colored light.

41. The machine of claim 31, wherein the engine operating time value allocated in the memory can be reset.

42. The machine of claim 31, wherein the perceptible alarm can be reset.

43. The machine of claim 31, wherein the memory allocation can comprise a RAM and an EEPROM.

44. The machine of claim 43, wherein the RAM is updated with the engine operating time at a predetermined frequency.

45. The machine of claim 44, wherein the EEPROM is updated with the engine operating time from the RAM at a predetermined frequency.
